(19) United States
(12) Patent Application Publication
(10) Pub. No.: US 2017/0059970 A1
(43) Pub. Date: Mar. 2, 2017

(54) SELF-PHOTOGRAPHIC MIRROR SUPPORT

(71) Applicant: DERRICK NIEVES, NEW HYDE PARK, NY (US)

(72) Inventor: DERRICK NIEVES, NEW HYDE PARK, NY (US)

(21) Appl. No.: 15/131,602

(22) Filed: Apr. 18, 2016

Related U.S. Application Data
(60) Provisional application No. 62/209,380, filed on Aug. 25, 2015.

(51) Int. Cl. G03B 17/56; H04N 5/225; H04N 5/232; G02B 7/182

(52) U.S. Cl. CPC G03B 17/566; G02B 7/182; G03B 17/561; G03B 17/565; H04N 5/2257; H04N 5/23206

(57) ABSTRACT

Technologies are described for methods and systems to support a mirror. The systems may comprise a mounting board with a top side and two or more bases attached to the top side of the mounting board at a first end of the bases. The bases may be configured to attach to a mirror at a second end of the bases. The systems may comprise bumpers attached to the top side of the mounting board. The bumpers may be configured to maintain a gap between the top side of the mounting board and the mirror. The systems may comprise a camera and a wireless transmitter attached to the top side of the mounting board, and a wire. The wire may connect the camera to the wireless transmitter. The systems may comprise a tubing secured to the top side of the mounting board. The wire may be threaded through the tubing.

### CROSS REFERENCE TO RELATED APPLICATIONS

This application claims priority to Provisional Application No. 62/209,380 filed Aug. 25, 2015, title “Self-Photographic Mirror Support”, the entirety of which is hereby incorporated by reference.

### BACKGROUND

This application relates to a structure and method to support a self-photographic mirror system. A mirror may be mounted on a mounting board such that the mirror is secured to the mounting board and supported by the mounting board. The mounting board may be mounted onto any surface such as a wall.

### SUMMARY

In some examples systems to support a mirror. The systems may comprise a mounting board with a top side. The systems may further comprise two or more bases attached to the top side of the mounting board at a first end of the bases. The bases may be configured to attach to a non-reflective surface of a mirror at a second end of the bases. The second end of the bases may be opposite the first end of the bases. The mirror may be supported by the bases. The systems may further comprise bumpers attached to the top side of the mounting board. The bumpers may be configured to maintain a gap between the top side of the mounting board and the non-reflective surface of the mirror. The systems may further comprise a camera attached to the top side of the mounting board. The systems may further comprise a wireless transmitter attached to the top side of the mounting board. The systems may further comprise a wire. The wire may connect the camera to the wireless transmitter. The systems may further comprise a tubing secured to the top side of the mounting board. The wire may be threaded through the tubing.

In some examples, methods effective to make a system to support a mirror. The methods may comprise attaching two or more bases to a top side of a mounting board at a first end of the bases. The bases may be configured to attach to a non-reflective surface of a mirror at a second end of the bases. The second end of the bases may be opposite the first end of the bases. The methods may further comprise attaching bumpers to the top side of the mounting board. The bumpers may be configured to maintain a gap between the top side of the mounting board and the non-reflective surface of the mirror. The methods may further comprise attaching a camera to the top side of the mounting board. The methods may further comprise attaching a wireless transmitter to the top side of the mounting board. The methods may further comprise attaching a tubing to the top side of the mounting board. The methods may further comprise connecting the camera and the wireless transmitter with a wire. The wire may be threaded through the tubing.

In some examples, systems effective to take a self-photograph. The systems may comprise a mounting board with a top side. The systems may further comprise two or more bases attached to the top side of the mounting board at a first end. The bases may be configured to attach to a non-reflective surface of a mirror at a second end of the bases. The second end of the bases may be opposite the first end of the bases. The systems may further comprise bumpers attached to the top side of the mounting board. The bumpers may be configured to maintain a gap between the top side of the mounting board and the non-reflective surface of the mirror. The systems may further comprise a camera attached to the top side of the mounting board. The systems may further comprise a wireless transmitter attached to the top side of the mounting board. The camera and the wireless transmitter may be connected by a wire. The wire may be threaded through a tubing. The tubing may be secured to the top side of the mounting board. The systems may further comprise a mirror attached at the second end of the bases. The non-reflective surface of the mirror may be attached at the second end of the bases. The systems may further comprise lights attached to the top side of the mounting board. The systems may further comprise a power source connected to the camera, the wireless transmitter, and the lights.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a front perspective view illustrating the components of a self-photographic mirror support system;

FIG. 2 is a side perspective view illustrating the components of a self-photographic mirror support system along with a supported mirror;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

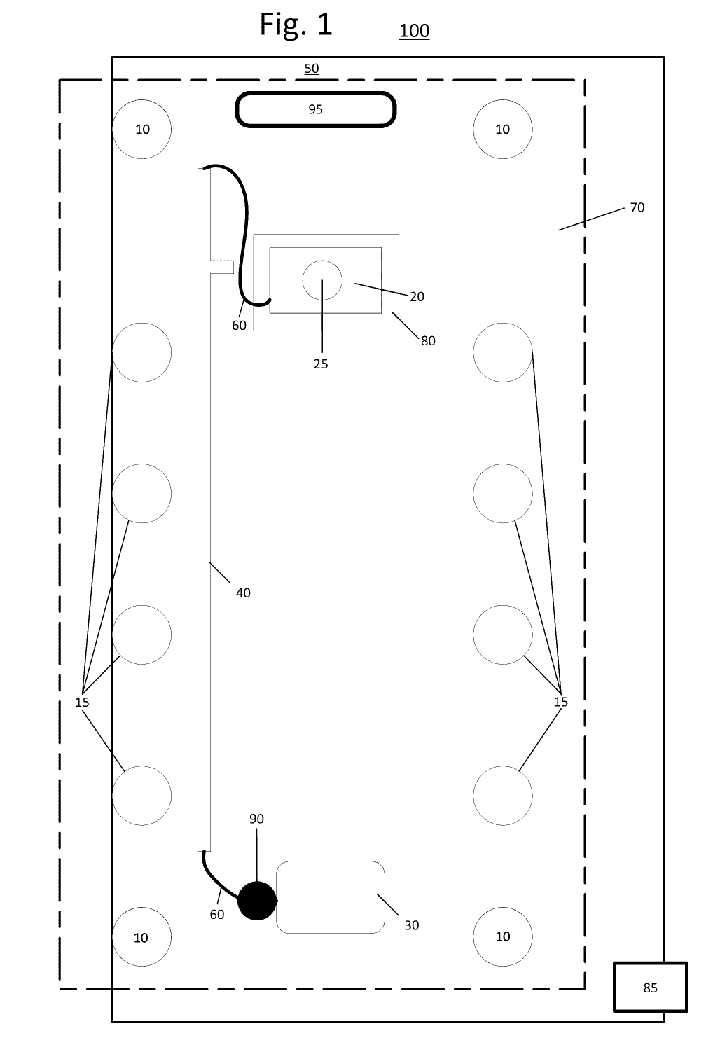

FIG. 1 a front perspective view illustrating the components of a self-photographic mirror support system 100, arranged in accordance with at least some embodiments presented herein. As discussed in more detail below, a self-photographic mirror support system may secure and support a mirror utilized to take a self-photograph

Support system 100 may include bases 10, bumpers 15, a camera 20, a wireless transmitter 30, tubing 40, a mounting board 50, and a wire 60. A mirror 70 may be attached to support system 100. Mirror 70 may include a non-reflective surface on a first side and a reflective surface on a second side. A bottom side of mounting board 50 may be mounted onto any solid surface. Mounting board 50 may be a solid supportive material such as acrylic, metal, wood, etc.

Bases 10 may be cylindrical in shape. A first circular end of bases 10 may be attached to a top side of mounting board 50. Bases 10 may be attached to mounting board 50 by an adhesive or an attachment device such as a screw or a clamp. At least some of bases 10 may be made of a metal or a structurally supportive material so as to be attachable to non-reflective surface of mirror 70. Non-reflective surface of mirror 70 may be attached to a second circular end, opposite the first circular end, of bases 10 by an adhesive or an attachment device such as a screw or a clamp. In some examples, non-reflective surface of mirror 70 may be mounted onto mounting board 50 using bases 10. Bases 10 may support mirror 70.

Bumpers 15 may be cylindrical, and may include a first circular end and a second circular end opposite the first circular end. First circular end of bumpers 15 may be attached to mounting board 50. Bumpers 15 may be attached to the top side of mounting board 50 by an adhesive or an attachment device such as a screw or a clamp. Bumpers 15 may maintain a gap between mounting board 50 attached at proximate end of bumpers 15 and non-reflective surface of mirror 70 attached or in contact with second circular end of bumpers 15. At least some of the bumpers 15 may be made of a shock resistant material, such as, for example, rubber or plastic or combinations thereof.

Camera 20 may include camera lens 25. Camera 20 may be mounted to mounting board 50 so that camera 20 is fixed between non-reflective surface of mirror 70 and the mounting board 50 with camera lens 25 facing non-reflective surface of mirror 70. Camera 20 may be attached to the top side of mounting board 50 by an adhesive or an attachment device such as VELCRO, tape, a screw or a clamp. In some examples, camera 20 may be mounted on a mounting plane 80. Mounting plane 80 may include a surface which is slanted relative to a plane formed by mirror 70 or by mounting board 50. Mounting plane 80 may be attached to the top side of mounting board 50 by an adhesive or an attachment device such as a screw or a clamp. Camera 20 may be attached to mounting plane 80 by an adhesive or an attachment device such as a screw or a clamp. Camera 20 may be mounted to mounting plane 80 and/or top side of mounting board 50 near an upper portion of mounting board 50.

Camera 20 may be connected to wireless transmitter 30. Wireless transmitter 30 may be secured to top side of mounting board 50. Wireless transmitter 30 may be attached to mounting board 50 by an adhesive or an attachment device such as VELCRO, tape, a screw or a clamp. Wireless transmitter 30 may be attached to mounting board 50 so as to be fixed between mounting board 50 and the non-reflective surface of mirror 70.

Wire 60 may connect camera 20 to wireless transmitter 30. Wire 60 may be threaded through tubing 40. Tubing 40 may be secured to top side of mounting board 50 between mounting board 50 and non-reflective surface of mirror 70 and may protect wire 60. Tubing 40 may be attached to mounting board 50 by an adhesive or an attachment device such as a screw or a clamp. Tubing 40 may be secured to mounting board 50 so as to be within the gap between the non-reflective surface of mirror 70 and mounting board 50. Wire 60 threaded through tubing 40 may be protected and/or at least partially enclosed by tubing 40. In some examples, tubing 40 may be circular tubing that has been cut in half axially and secured to mounting board 50 at the cut side. In such an example, wire 40 may be threaded through a half-cylindrical “sheath” formed by tubing 40 and mounting board 50.

A lower portion of mounting board 50 may define a hole 90 cut out of mounting board 50. Hole 90 may allow a pathway for a connection from a power source 85 to camera 20 and/or wireless transmitter 30. Power source 85 may provide power to camera 20 and/or wireless transmitter 30. In some examples, power source 85 may be a battery or a wire connected to an electrical outlet.

In various other examples, light sources 95 may be installed between mounting board 50 and the non-reflective surface of mirror 70. In some cases, light sources 95 may be powered by power source 85 along with camera 20 and/or wireless transmitter 30. Light sources 95 may include light emitting diodes (“LEDs”), incandescent lights, and/or fluorescent lights.

As described in more detail below, a self-photographic mirror support 100 may support mirror 70 and camera 20 to take a photograph of a user. A user may position themselves by viewing their image in supported mirror 70 and may take a photograph with camera 20.

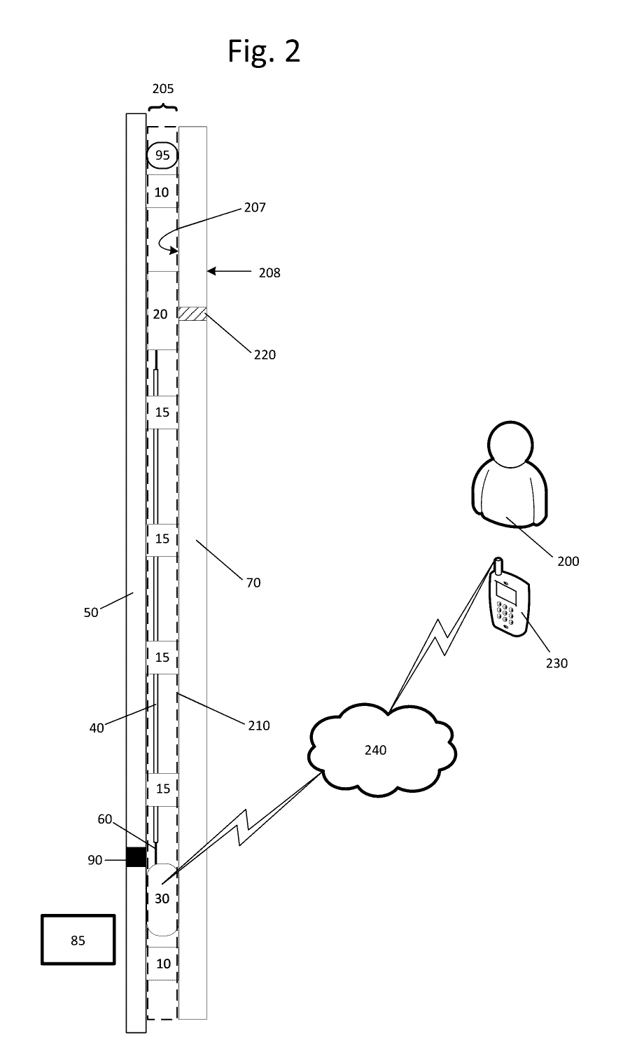

FIG. 2 is a side perspective illustrating the components of a self-photographic mirror support along with a supported mirror, arranged in accordance with at least some embodiments presented herein. Those components in FIG. 2 that are labeled identically to components of FIG. 1 will not be described again for the purposes of clarity.

Wireless transmitter 30 may communicate over network 240. In some examples, network 240 may be, or include, the Internet, a local area network and/or a wide area network, a Wi-Fi network and/or a BLUETOOTH network, etc. Mobile device 230 may communicate with wireless transmitter 30 through network 240. Wireless transmitter 30 may communicate with camera 20 through wire 60. Camera 20 may be operated by an application (“app”) installed on, for example, mobile device 230. Mobile device 230 may allow user 200 to operate camera 20 in order to take a photograph. For example, application installed on mobile device 230 may allow mobile device 230 to communicate with wireless transmitter 30 through network 240 to operate camera 20

In some other examples, side rails 210 may be attached along the sides of mounting board 50. Side rails 210 may conceal a gap 205 between the non-reflective surface 207 of mirror 70 and mounting board 50 so that gap 205 may not be visible from the side of the support 100 attached to mirror 70.

In some examples, camera 20, wireless transmitter 30, bumpers 10, wire 60, lighting 95, and/or tubing 40 may be concealed from the view of someone looking into the reflective surface of mirror 70. For example, concealing pieces, such as side rails 210 may be installed between mirror 70 and mounting board 50 along the perimeter of mirror 70 to conceal the components located within the gap between mounting board 50 and the non-reflective surface 207 of mirror 70.

Mirror 70 may define a hole 220 through mirror 70 from non-reflective surface 207 of mirror 70 to reflective surface 208 of mirror 70. Hole 220 in mirror 70 may be positioned so as to align with camera lens 25 and allow camera lens 25 to detect and focus on images through mirror 70. Hole 220 may not be visible, or may be concealed so as not to be visible by a user looking at the reflective side of mirror 70.

### EXAMPLE

Four metal bases 10 were attached to a top side of mounting board 50, each base 10 was attached 4 ½″ in from a side edge and 3⅝″ in from a top/bottom edge at each of the four corners of a 52″×18″×⅜″ acrylic mounting board 50. Metal bases 10 were attached with screws through mounting board 50 and into a first end of bases 10. Metal bases 10 were cylindrical in shape, 1⅛″ tall with a 1″ radius.

Eight bumpers 15 were also attached to the top side of mounting board 50. The bumpers 15 were attached in two rows, each row 4½″ in from the side edges and in line with metal bases 10. Bumpers were attached at 16 1/7″, 27″, 33 9/16″, and 40¼″ from the top edge of mounting board 50.

First circular sides of two bases 10 were attached to a top surface of mounting board 50 along an upper edge of mounting board 50. Camera 20 was attached to the top surface of mounting board 50 interior and lower on mounting board 50 than the previously attached two bases 10. A first circular side of two additional bases 10 were attached to the top surface of mounting board 50 along a lower edge of mounting board 50. Wireless transmitter 30 was attached to the top surface of mounting board 50 interior and higher on mounting board 50 than additional bases 10. Wire 60 was connected between camera 20 and wireless transmitter 30 through tubing 40.

Tubing 40 was attached to the top side of mounting board 50 running from camera 20 to wireless transmitter 30 so as to protect wire 60 between camera 20 and wireless transmitter 30. Tubing 40 was 1″ diameter plastic tubing, 38″ in length. Four bumpers 15 were attached to top surface of mounting board 50 along a left edge and a right edge of mounting board 50 between bases 10 proximate to the upper edge of mounting board 50 and additional bases 10 along a lower edge of mounting board 50.

Mirror 70 was secured to bases 10 with one screw through each corner of mirror 70 into second ends of respective bases 10. Mirror 70 was secured with non-reflective side towards bases 10 and top side of mounting board 50.

A system in accordance with the present disclosure may enable a user to take a self-photograph with the camera not in the self-photograph. A user may be able to easily pose while watching a reflected image in the mirror and then take a better self-portrait. The disclosed system may allow self-portraits to be taken from various angles and configurations based upon where the system is positioned and hung.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system to support a mirror, the system comprising:
a mounting board with a top side;
two or more bases attached to the top side of the mounting board at a first end of the bases, wherein the bases are configured to attach to a non-reflective surface of a mirror at a second end of the bases, the second end of the bases being opposite the first end of the bases, the mirror being supported by the bases;
bumpers attached to the top side of the mounting board, wherein the bumpers are configured to maintain a gap between the top side of the mounting board and the non-reflective surface of the mirror;
a camera attached to the top side of the mounting board;
a wireless transmitter attached to the top side of the mounting board;
a wire, wherein the wire connects the camera to the wireless transmitter; and
a tubing secured to the top side of the mounting board, wherein the wire is threaded through the tubing.

2. The system of claim 1, wherein the mounting board is acrylic.

3. The system of claim 1, wherein the bases are metal, and the bases are attached to the mounting board with screws.

4. The system of claim 1, wherein the bumpers include a shock resistant material.

5. The system of claim 1, wherein the bumpers include rubber or plastic.

6. The system of claim 1, further comprising a mirror, wherein a non-reflective surface of the mirror is attached at the second end of the bases.

7. The system of claim 6, wherein the mirror is attached to the bases with screws.

8. The system of claim 1, further comprising a power source connected to the camera and the wireless transmitter.

9. The system of claim 1, wherein the wireless transmitter communicates over the Internet.

10. The system of claim 1, further comprising a mobile device, wherein an application installed on the mobile device is effective to allow the mobile device to communicate with the wireless transmitter over a network and operate the camera to take a photograph.

11. The system of claim 1, further comprising lights attached to the top side of the mounting board.

12. The system of claim 6, further comprising side rails attached to the side edges of the mounting board, wherein the side rails conceal a gap between the mounting board and the non-reflective surface of the mirror.

13. A method for making a system to support a mirror, the method comprising:
attaching two or more bases to a top side of a mounting board at a first end of the bases, wherein the bases are configured to attach to a non-reflective surface of a mirror at a second end of the bases, the second end of the bases being opposite the first end of the bases;
attaching bumpers to the top side of the mounting board, wherein the bumpers are configured to maintain a gap between the top side of the mounting board and the non-reflective surface of the mirror;
attaching a camera to the top side of the mounting board;
attaching a wireless transmitter to the top side of the mounting board;
attaching a tubing to the top side of the mounting board; and
connecting the camera and the wireless transmitter with a wire, wherein the wire is threaded through the tubing.

14. The method of claim 13, wherein the bases are metal and the attaching is performed with screws.

15. The method of claim 13, wherein the bumpers include a shock resistant material.

16. The method of claim 13, further comprising attaching a non-reflective surface of a mirror to a distal end of the bases with screws.

17. The method of claim 13, further comprising connecting a power source to the camera and the wireless transmitter.

18. The method of claim 13, further comprising attaching lights to the top side of the mounting board.

19. A system effective to take a self-photograph, the system comprising:
a mounting board with a top side;
two or more bases attached to the top side of the mounting board at a first end, wherein a the bases are configured to attach to a non-reflective surface of a mirror at a second end of the bases, the second end of the bases being opposite the first end of the bases;
bumpers attached to the top side of the mounting board, wherein the bumpers are configured to maintain a gap between the top side of the mounting board and the non-reflective surface of the mirror;
a camera attached to the top side of the mounting board;
a wireless transmitter attached to the top side of the mounting board, wherein the camera and the wireless transmitter are connected by a wire and the wire is threaded through a tubing, the tubing being secured to the top side of the mounting board;
a mirror attached at the second end of the bases, wherein the non-reflective surface of the mirror is attached at the second end of the bases;
lights attached to the top side of the mounting board; and
a power source connected to the camera, the wireless transmitter, and the lights.

20. The system of claim 19, further comprising a mobile device, wherein an application installed on the mobile device is effective to allow the mobile device to communicate with the wireless transmitter over a network and operate the camera to take a photograph.
